(19) United States
(12) Patent Application Publication
(10) Pub. No.: US 2005/0229753 A1
(43) Pub. Date: Oct. 20, 2005

(54) Collapsible toolkit

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/825,538

(22) Filed: Apr. 15, 2004

(51) Int. Cl. B25F 1/00

(52) U.S. Cl. 81/437

(57) ABSTRACT

A simple and robust collapsible toolkit is disclosed. The collapsible toolkit includes a first frame, a second frame connected with the first frame and at least one tool of a first type pivotally connected with the first frame between a collapsed position in the first frame and an extended position outside the first frame.

### FIELD OF INVENTION

The present invention relates to a collapsible toolkit.

### BACKGROUND OF INVENTION

Referring to FIGS. 7 to 10, an extensible toolkit includes a first tool 110 and a second tool 120. The tools 110 and 120 are covered by means of an upper cover 130 and a lower cover 130′. The first tool 110 includes a polygonal space 111, a slot 112 communicated with the polygonal space 111 and pairs of recesses 113 communicated with the slot 112. The first tool 110 further includes a first type of screwdriver 114. The second tool 120 includes a slide 121 for sliding in the polygonal space 111, a recess 122 defined in the slide 121, a shank 123 for sliding in the slot 112, a hole 128 defined in the top of the shank 123 and two holes 125 defined in two sides of the shank 123 and communicated with the hole 128. The second tool 120 further includes a second type of screwdriver 127. The polygonal hole 111 and the recess 122 cooperate in order to receive a bolt or nut. That is, the tools 110 and 120 form a wrench. A detent 126 is trapped in each hole 125. The detents 126 can be put in selective one of the pairs of recesses 113 so as to retain the second tool 120 in selective one of positions relative to the first tool 110. A spring 129 and a button 124 are put in the hole 128. The button 124 includes two recesses each with a shallow portion and a deep portion. The button 124 can lock and release the detents 126. The upper cover 130 is secured to the lower use of the extensible toolkit. Firstly, it is inconvenient and sometimes dangerous to carry the extensible toolkit because the screwdrivers 114 and 127 are always exposed. Secondly, the holes 125 and 128, the detents 126, the spring 129 and the button 124 form a complicated mechanism for locking the second tool 120 in position relative to the first tool 110. Thirdly, the rivets 131 are inadequate to hold the tools 110 and 120 and the covers 130 and 130′ together. Fourthly, the rivets 131 are aesthetically unpleasing.

The present invention is therefore intended to obviate or at least alleviate the problems encountered in prior art.

### SUMMARY OF INVENTION

It is an objective of the present invention to provide a collapsible toolkit that can be carried conveniently and safely.

It is an objective of the present invention to provide a simple collapsible toolkit.

It is another objective of the present invention to provide a robust collapsible toolkit.

According to the present invention, a collapsible toolkit includes a first frame, a second frame connected with the first frame and at least one tool of a first type pivotally connected with the first frame between a first frame.

Other objects, advantages and novel features of the invention will become more apparent from the following detailed description in conjunction with the attached drawings.

### BRIEF DESCRIPTION OF DRAWINGS

The present invention will be described via detailed illustration of the preferred embodiment referring to the drawings.

FIG. 1 is a perspective view of a collapsible toolkit according to the preferred embodiment of the present invention.

FIG. 2 is an exploded view of the collapsible toolkit of FIG. 1.

FIG. 3 is similar to FIG. 1 but shows the collapsible toolkit in another position.

FIG. 4 is a top view of the collapsible toolkit of FIG. 1 in another position.

FIG. 5 is similar to FIG. 4 but shows the collapsible toolkit in another position.

FIG. 6 is similar to FIG. 4 but shows the collapsible toolkit in another position.

FIG. 7 is an exploded view of an extensible toolkit of prior art.

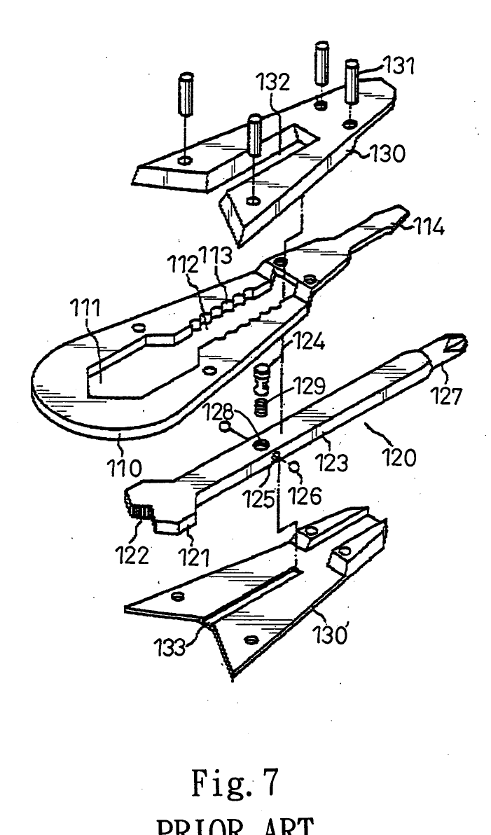

FIG. 8 is a perspective view of the extensible toolkit of FIG. 7.

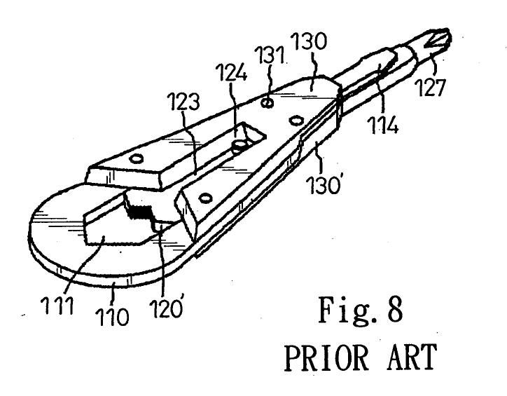

FIG. 9 is a cross-sectional view of the extensible toolkit of FIG. 8.

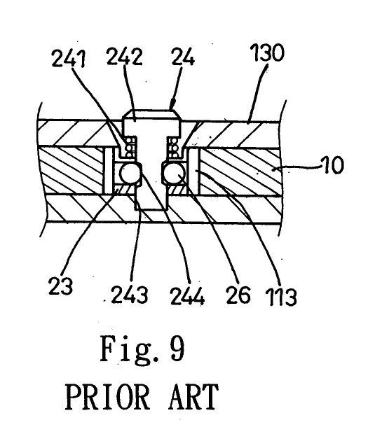

FIG. 10 is a top view of the extensible toolkit of FIG. 8.

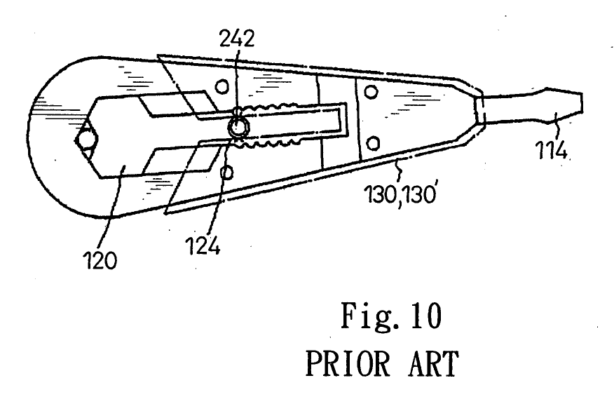

### DETAILED DESCRIPTION OF PREFERRED EMBODIMENT

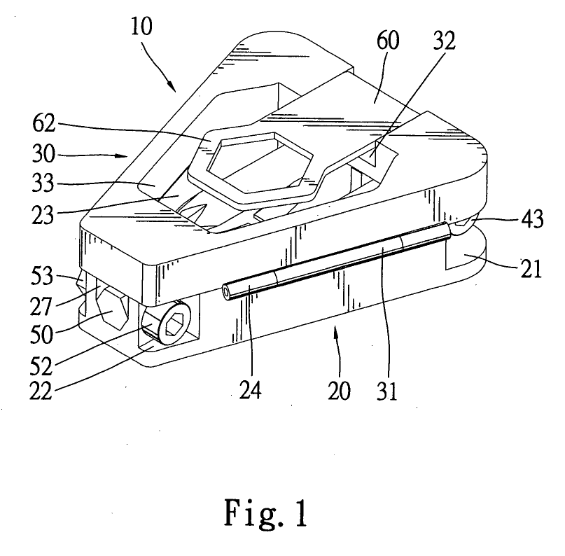

FIG. 1 shows a collapsible toolkit 10 in a collapsed position according to the preferred embodiment.

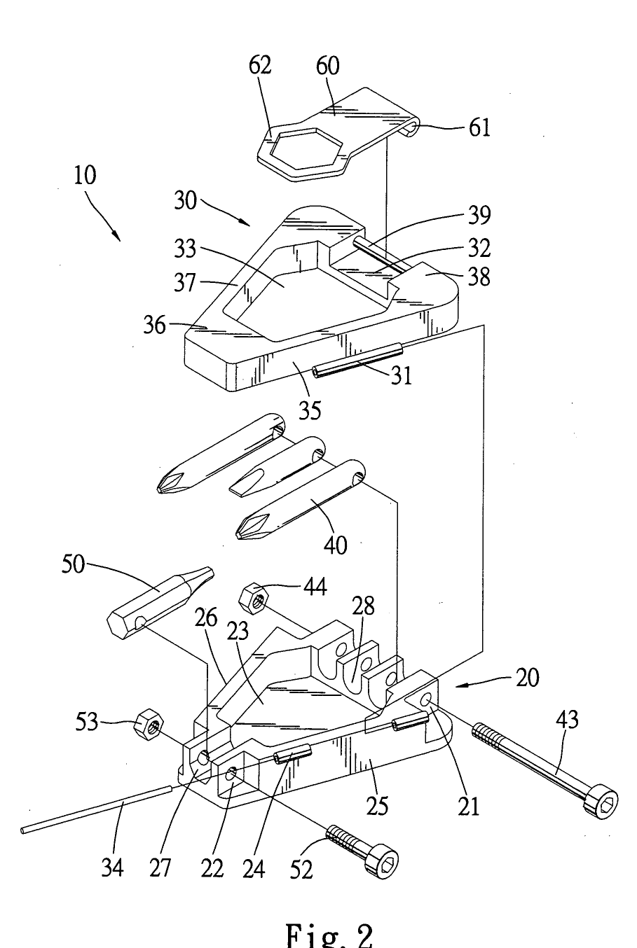

Referring to FIG. 2, the collapsible toolkit 10 includes a first frame 20, a second frame 30 pivotally connected with the first frame 20, at least one tool 40 of a first type pivotally connected with the first frame 20, at least one tool 50 of a second type pivotally connected with the first frame 20 and at least one tool 60 of a third type pivotally connected with the second frame 30.

The first frame 20 includes a first member 25, a second member 22 next to the first member 25, a third member 26 next to the second member 22 and a fourth member 21 between the third member 26 and first member 25. A space 23 is defined in the members. Two tubes 24 are formed on the first member 25. A recess 27 is defined in the second member 22. Recesses 28 are defined in the fourth member 21.

The second frame 30 includes a first member 35, a second member 36 next to the first member 35, a third member 37 next to the second member 36 and a fourth member 38 between the third member 37 and first member 35. A space 33 is defined between the members 35 to 38. A tube 31 is formed on the first member 35. A recess 32 is defined in the fourth member 38. A shaft 39 is formed on the fourth member 38 spanning the recess 32.

A pin 34 is fit in the tubes 24 and 31 so as to pivotally connect the first frame 20 with the second frame 30. The pin 34 and the tubes 24 and 31 form a hinge.

An end of the tool 50 is put in the recess 27. The tool 50 is pivotally connected with the second member 22 by means of a bolt 52 engaged with a nut 53. The second member 22 is adequately thick so as to encompass the bolt 52. The tool 50 can be put in the space 23.

There are three tools 40 as shown. An end of each of the tools 40 is put in related one of the recesses 28. The tools 40 are pivotally connected with the fourth member 21 by means of a bolt 43 engaged with a nut 44. The fourth member 21 is adequately thick so as to encompass the bolt 43. The tools 40 can be put in the space 23. The tools 40 are screwdrivers.

The tool 60 includes a hook 61 for hooking the shaft 39 and an annular head 62 for driving a bolt or nut. The hook 61 is put in the recess 32. The tool 60 can be put in the space 33. The tool 60 is a box wrench.

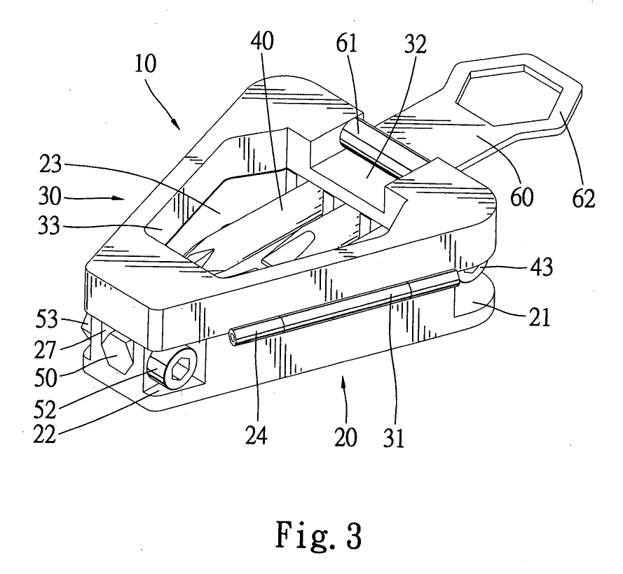

Referring to FIG. 3, the tool 60 is pivoted from the space 33. Now, the collapsible toolkit 10 is used as a wrench.

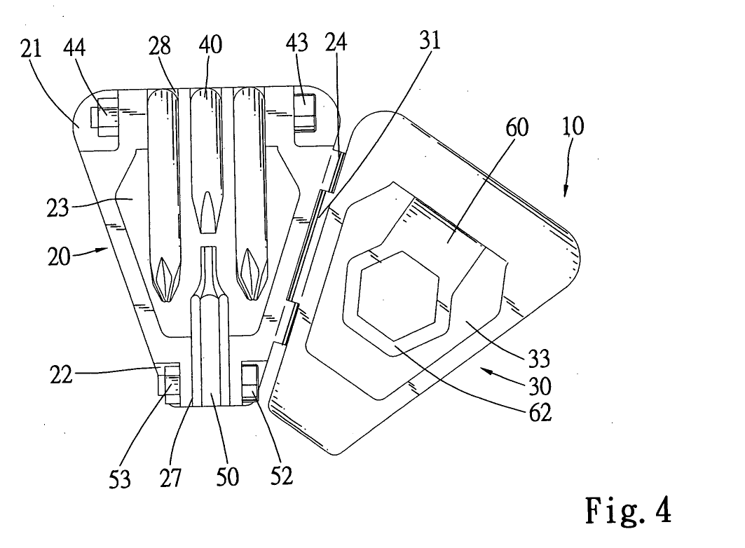

Referring to FIG. 4, the second frame 30 is pivoted from the first frame 20 so that the tools 40 and 50 can be pivoted from the space 23.

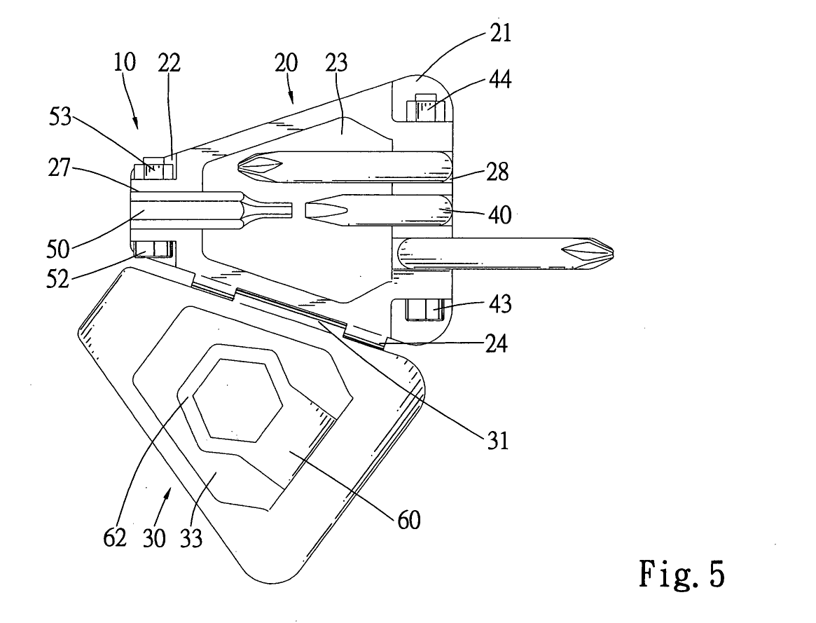

Referring to FIG. 5, one of the tools 40 is pivoted from the space 23. The collapsible toolkit 10 is used as a screwdriver.

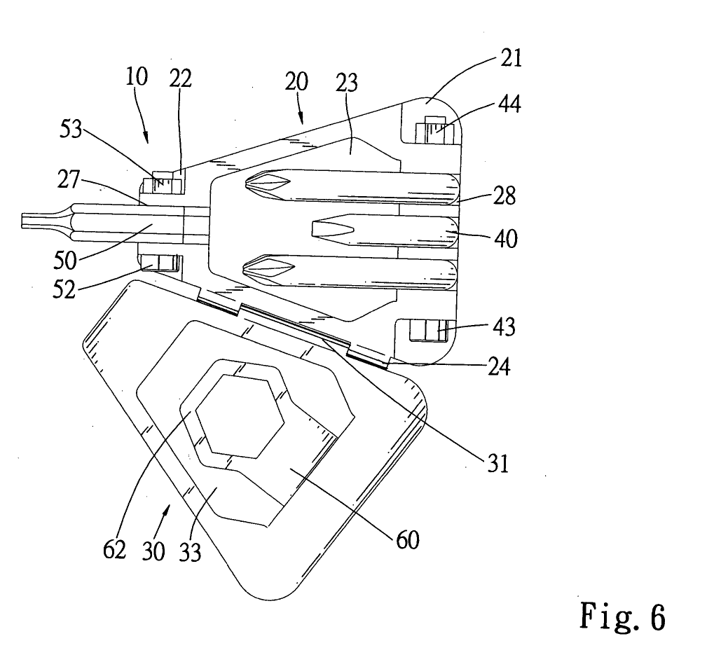

Referring to FIG. 6, the tool 50 is pivoted from the space 23 for use. The tool 50 is an Allen key.

The collapsible toolkit 10 is simple for saving detents and a button for control such detents. The collapsible toolkit 10 is robust for including bolts for securing tools.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. A collapsible toolkit includes a first frame, a second frame connected with the first frame and at least one tool of a first type pivotally connected with the first frame between a collapsed position in the first frame and an extended position outside the first frame.

2. The collapsible toolkit according to claim 1 wherein the first frame defines a space for receiving the tool of the first type.

3. The collapsible toolkit according to claim 1 including a bolt for pivotally connecting the tool of the first type with the first frame.

4. The collapsible toolkit according to claim 1 wherein the first frame includes at least one recess for receiving an end of the tool of the first type.

5. The collapsible toolkit according to claim 1 including at least one tool of a second type pivotally connected with the first frame between a collapsed position in the first frame and an extended position outside the first frame.

6. The collapsible toolkit according to claim 5 including a bolt for pivotally connecting the tool of the second type with the first frame.

7. The collapsible toolkit according to claim 5 wherein the first frame includes at least one recess for receiving an end of the tool of the second type.

8. The collapsible toolkit according to claim 5 wherein the tool of the second type is an Allen key.

9. The collapsible toolkit according to claim 5 wherein the first frame defines a space for receiving the tool of the second type.

10. The collapsible toolkit according to claim 5 including at least one tool of a third type connected with the second frame between a collapsed position in the second frame and an extended position outside the second frame.

11. The collapsible toolkit according to claim 10 wherein the second frame includes a shaft formed thereon for supporting the tool of the third type.

12. The collapsible toolkit according to claim 11 wherein the tool of the third type includes a hook for hooking the shaft of the second frame.

13. The collapsible toolkit according to claim 10 wherein the second frame includes at least one recess for receiving an end of the tool of the third type.

14. The collapsible toolkit according to claim 10 wherein the tool of the third type is a wrench.

15. The collapsible toolkit according to claim 14 wherein the wrench is a box wrench.

16. The collapsible toolkit according to claim 1 wherein the first frame is pivotally connected with the second frame.

17. The collapsible toolkit according to claim 16 including a hinge for connecting the first frame with the second frame.

18. The collapsible toolkit according to claim 17 wherein the hinge includes two tubes formed on the first frame, a tube formed on the second frame and a pin inserted in the tubes formed on the first frame and the tube formed on the second frame.

19. The collapsible toolkit according to claim 10 wherein the second frame defines a space for receiving the tool of the third type.
